(19) United States
(12) Patent Application Publication
(10) Pub. No.: US 2025/0390002 A1
(43) Pub. Date: Dec. 25, 2025

(54) Optical Device

(71) Applicant: Nippon Telegraph and Telephone Corporation, Tokyo (JP)

(72) Inventor: Hidetaka Nishi, Musashino-shi, Tokyo (JP)

(21) Appl. No.: 18/877,557

(22) PCT Filed: Jun. 27, 2022
(86) PCT No.: PCT/JP2022/025508

§ 371 Date: Dec. 20, 2024

(51) Int. Cl. G02F 1/39

(52) U.S. Cl. CPC G02F 1/395

(57) ABSTRACT

The optical device includes a lower cladding layer, a first core, and a second core. The first core and the second core are formed on the lower cladding layer. The first core is disposed above the second core when viewed from the lower cladding layer side. A refractive index and a sectional shape of each of the first core and the second core, and a positional relationship between the first core and the second core in a section perpendicular to a waveguide direction have a relationship in which a propagation constant of input light is equal to a sum of propagation constants of two light waves generated through a nonlinear process by the input light propagating through an optical waveguide having a super mode.

### TECHNICAL FIELD

The present invention relates to an optical device including an optical waveguide made of a material having a nonlinear optical effect.

### BACKGROUND ART

In recent years, development of optical integrated device technologies using a minute optical waveguide has progressed. Among optical waveguides, an LN optical waveguide, in which lithium niobate (LN) with a nonlinear optical effect is used as a core material, an insulating material such as silicon oxide is used as a cladding material, and a core having dimensions for realizing a single mode is used, has attracted attention. This LN optical waveguide can exhibit a nonlinear optical effect with high efficiency by obtaining strong optical confinement in a core made of LN, and high-performance elements such as a wavelength conversion element, a phase sensitive amplification element, a quantum entangled photon pair source, and a frequency comb light source that can operate with low power consumption are realized.

Incidentally, in order to efficiently exhibit the nonlinear optical effect, it is important to satisfy mutual phase matching conditions when pieces of light with different wavelengths related to the nonlinear optical process propagate. In an optical waveguide type nonlinear optical element, various methods have been proposed in order to satisfy the phase matching condition, and the following two methods are mainly mentioned.

First, there is a method of designing an effective refractive index of an optical waveguide propagation mode so as to satisfy a phase matching condition represented by a relational expression of “βₚ=βₛ+βᵢ . . . (1)” between a propagation constant βₚ of a fundamental light wave and propagation constants βₛ and βᵢ of light waves generated through a nonlinear process (for example, two light waves through spontaneous parametric down-conversion: SPDC).

For example, in Non Patent Literature 1, when wavelengths are different, a large difference occurs in the propagation constant between fundamental modes, and thus, a design is made such that Expression 1 is satisfied for the fundamental mode and the higher order mode, or the fundamental mode and the orthogonal polarization mode.

Second, there is a method of imparting a periodic polarization inversion structure having a period A to satisfy a phase matching condition represented by the relational expression “βₚ−(βₛ+βᵢ)=2π/Λ . . . (2)”. The periodic polarization inversion structure is a structure in which a polarity direction of polarization perpendicular to a light propagation direction is inverted every length of Λ/2 with respect to the light propagation direction (Non Patent Literature 2).

### CITATION LIST

### Non Patent Literature

Non Patent Literature 1: J. Y. CHEN et al., “Modal phase matched lithium niobate nanocircuits for integrated nonlinear photonics”, OSA Continuum, vol. 1, no. 1, pp. 229-242, 2018.
Non Patent Literature 2: C. WANG et al., “Ultrahigh-efficiency wavelength conversion in nanophotonic periodically poled lithium niobate waveguides”, Optica, Vol. 5, no. 11, pp. 1438-1441, 2018.

### SUMMARY OF INVENTION

### Technical Problem

However, the conventional technique has the following problems.

In order to obtain the phase matching condition of Expression (1), it is necessary to use a higher order mode or a quadrature polarization mode. However, in a case where phase matching with a higher order mode having a plurality of electric field intensity peaks in the horizontal direction is adopted as used in Non Patent Literature 1, such a mode is likely to be lost in the bent optical waveguide. For example, when an electric field enhancement effect is achieved by using a ring resonator to further increase efficiency, such a mode is a big problem. Even when phase matching with the orthogonal polarization mode is adopted, the TM mode is more likely to be lost in the bent optical waveguide than the TE mode, and thus, has a similar problem.

In order to obtain the phase matching condition of Expression (2), there is a problem that an extremely advanced production process of periodically moving an element domain in the LN crystal by applying a high voltage along the Z-axis direction in the crystal is essential. In particular, in the production of a ring resonator, a ring resonator manufactured by using a Z-cut thin film LN crystal substrate has an excellent feature that a periodic polarization inversion structure can be produced anywhere in the ring.

However, this configuration has problems that, because it is necessary to form electrodes on a front surface and a back surface of a substrate and apply a high voltage in the normal direction of the substrate having a thickness of several hundred μm to 1 mm, high technical power is required for the manufacturing, and a region in which polarization between the electrodes is not uniformly inverted may occur even when a high voltage is applied. On the other hand, in the X-cut (Y-cut) LN crystal, since the Z-axis is in the direction of the propagation plane of the optical waveguide, there is a big problem that a continuous periodic polarization inversion structure cannot be imparted to the entire ring.

As described above, the conventional technique has a problem that a loss is likely to occur in the bent optical waveguide, and it is not easy to exhibit a nonlinear optical effect in a case where a ring resonator is used.

The present invention has been made to solve the above problems, and an object of the present invention is to suppress a loss in a bent optical waveguide and easily exhibit a nonlinear optical effect even in a case where a ring resonator is used.

### Solution to Problem

According to the present invention, there is provided an optical device including a first core formed on a lower cladding layer and having a nonlinear optical effect; and a second core formed on the lower cladding layer, in which the first core and the second core constitute an optical waveguide having a super mode, and a refractive index and a sectional shape of each of the first core and the second core, and a positional relationship between the first core and the second core in a section perpendicular to a waveguide direction have a relationship in which a propagation constant of input light is equal to a sum of propagation constants of two light waves generated through a nonlinear process by the input light propagating through the optical waveguide having the super mode.

### Advantageous Effects of Invention

As described above, according to the present invention, it is possible to suppress a loss in a bent optical waveguide and easily exhibit a nonlinear optical effect even in a case where a ring resonator is used.

### BRIEF DESCRIPTION OF DRAWINGS

FIG. 1 is a sectional view illustrating a configuration of an optical waveguide according to an exemplary embodiment of the present invention.

FIG. 2A is a distribution diagram illustrating electromagnetic field distributions of incident light modes in a first core 102 and a second core 103.

FIG. 2B is a distribution diagram illustrating electromagnetic field distributions of propagation modes of light generated through an SPDC process in the first core 102 and the second core 103.

FIG. 3A is a characteristics diagram illustrating changes in an effective refractive index of incident light and an effective refractive index of light generated through an SPDC process when a core width of the first core 102 is changed in a case where a core width of the second core 103 is set to 800 nm.

FIG. 3B is a characteristics diagram illustrating changes in the effective refractive index of incident light and the effective refractive index of light generated through the SPDC process when the core width of the first core 102 is changed in a case where the core width of the second core 103 is set to 850 nm.

FIG. 3C is a characteristics diagram illustrating changes in the effective refractive index of incident light and the effective refractive index of light generated through the SPDC process when the core width of the first core 102 is changed in a case where the core width of the second core 103 is set to 900 nm.

FIG. 4 is a characteristics diagram illustrating a relationship between a core width of the first core 102 and a core width of the second core 103 in which a phase matching condition is obtained in a case where a distance between the first core 102 and the second core 103 is changed.

FIG. 5 is a perspective view illustrating a configuration of an integrated optical device to which the optical device according to the embodiment is applied.

FIG. 6A is a distribution diagram illustrating propagation modes of light in an output optical waveguide of a membrane laser 202 of the integrated optical device to which the optical device according to the embodiment is applied.

FIG. 6B is a distribution diagram illustrating propagation modes of light in a ring optical waveguide 205 of the integrated optical device to which the optical device according to the embodiment is applied.

FIG. 6C is a distribution diagram illustrating propagation modes of light in the ring optical waveguide 205 of the integrated optical device to which the optical device according to the embodiment is applied.

### DESCRIPTION OF EMBODIMENTS

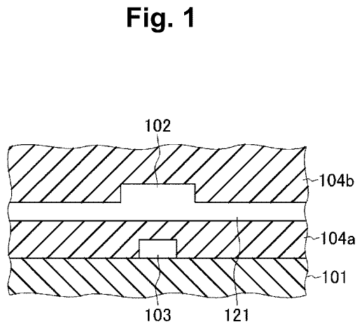

Hereinafter, an optical device according to an embodiment of the present invention will be described with reference to FIG. 1. The optical device includes a lower cladding layer 101, a first core 102, and a second core 103. The first core 102 and the second core 103 are formed on the lower cladding layer 101. In this example, the first core 102 is disposed above (immediately above) the second core 103 when viewed from the lower cladding layer 101 side.

An intermediate cladding layer 104a is formed between the first core 102 and the second core 103, and an upper cladding layer 104b is formed on the first core 102. In this example, the first core 102 is of a ridge type (rib type) and includes a slab layer 121, and the second core 103 is of a channel type.

The first core 102 (slab layer 121) is made of a material having a nonlinear optical effect. The first core 102 (slab layer 121) may be formed by processing, for example, an X-cut lithium niobate (LN) substrate. The second core 103 may be made of InP.

The lower cladding layer 101, the intermediate cladding layer 104a, and the upper cladding layer 104b may be made of SiO₂. For example, the lower cladding layer 101 may be made of silicon oxide formed by thermally oxidizing a surface of a silicon substrate. The intermediate cladding layer 104a and the upper cladding layer 104b may be formed by depositing SiO₂ by using a CVD method.

The intermediate cladding layer 104a and the upper cladding layer 104b may be air (space). The second core 103 may be of a rib type. In this case, a spacer may be disposed at any position between the slab layer of the second core 103 of a rib type and the slab layer 121 of the first core 102 of a rib type such that the slab layers are not in contact. By disposing the spacer, the slab layer 121 of the first core 102 of a rib type can be disposed apart from the slab layer of the second core 103 of a rib type, and thus the space (intermediate cladding layer 104a) between the two can be a layer of air.

The first core 102 and the second core 103 constitute an optical waveguide having a super mode. A refractive index and a sectional shape of each of the first core 102 and the second core 103, and a positional relationship between the first core 102 and the second core 103 in a section perpendicular to the waveguide direction have a relationship in which a propagation constant of input light is equal to a sum of propagation constants of two light waves generated through the nonlinear process by the input light propagating through the optical waveguide having the super mode.

In other words, a refractive index and a sectional shape of each of the first core 102 and the second core 103, and a positional relationship between the first core 102 and the second core 103 in a section perpendicular to the waveguide direction have a relationship in which the propagation constant βₚ of the input light and the propagation constants βₛ and βᵢ of the respective two light waves generated through the nonlinear process by the input light propagating through the optical waveguide having the super mode satisfy “βₚ=βₛ+βᵢ . . . (1)”

For example, the first core 102 may have a core width of 1500 nm and a core height of 600 nm. The slab layer 121 may be 300 nm thick. An interval (gap) between the first core 102 and the second core 103 in the thickness direction may be 200 nm. The center of the first core 102 and the center of the second core 103 in a plane direction of the lower cladding layer 101 in a plane perpendicular to the waveguide direction can coincide with each other.

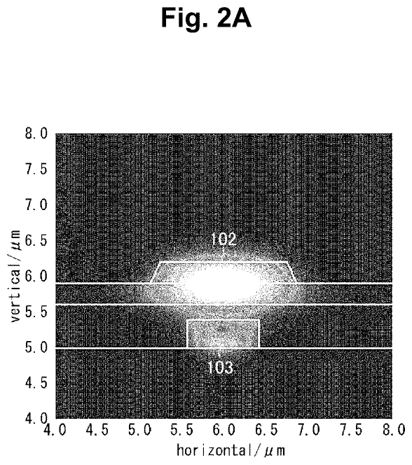

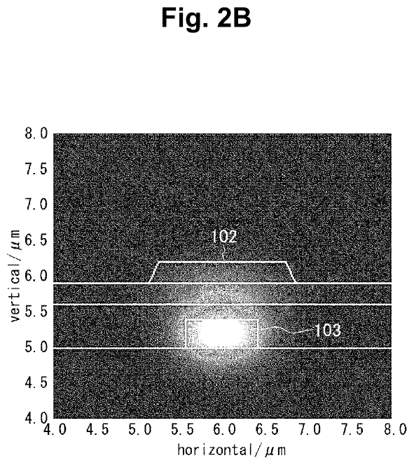

FIGS. 2A and 2B illustrate electromagnetic field distributions of light propagation modes in the first core 102 and the second core 103 calculated under the respective conditions described above. FIG. 2A illustrates an electromagnetic field distribution of an incident light mode which is a TE mode in which an electromagnetic field distribution mainly exists in the first core 102 at a wavelength of 1550 nm and has a propagation constant βₚ. FIG. 2B illustrates a TE mode at a wavelength of 3100 nm generated through a nonlinear process (spontaneous parametric down-conversion: SPDC) process, and illustrates a super mode in which electromagnetic field distributions exist in both the first core 102 and the second core 103. In the mode illustrated in FIG. 2B, a light confinement coefficient for the first core 102 is 17%.

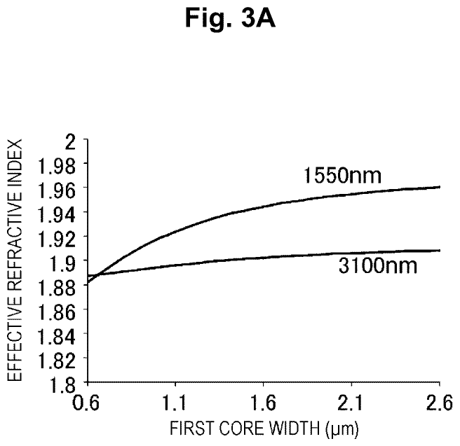

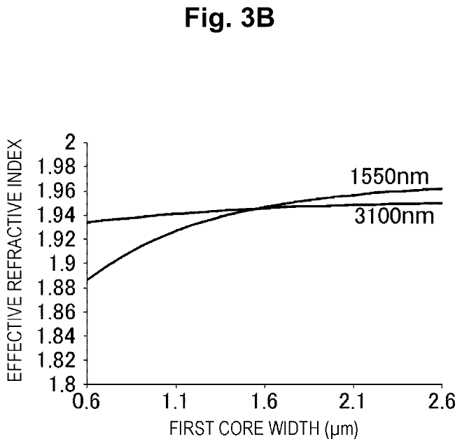

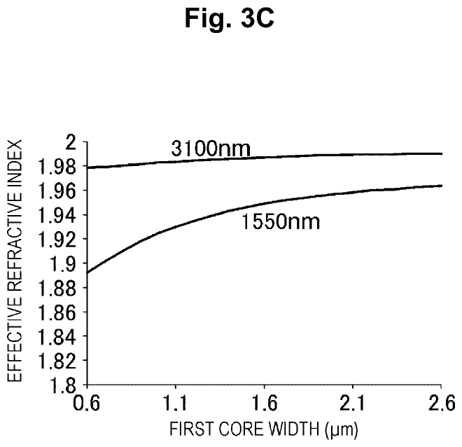

Next, FIGS. 3A, 3B, and 3C illustrate calculation results of changes in an effective refractive index (wavelength of 1550 nm) of incident light and an effective refractive index (wavelength of 3100 nm) of light generated through the SPDC process in a case where the core width of the first core 102 is changed. FIG. 3A illustrates a case where the core width of the second core 103 is 800 nm. FIG. 3B illustrates a case where the core width of the second core 103 is 850 nm. FIG. 3C illustrates a case where the core width of the second core 103 is 900 nm.

It can be seen that when the core width of the second core 103 is increased, the effective refractive index is increased in the light propagation mode in which the light leakage from the first core 102 is strong and the wavelength is 3100 nm. Here, for the sake of simplicity, assuming that βₛ and βᵢ are close in wavelength and substantially the same, in Expression (1), a phase matching condition is obtained near a point where the effective refractive indexes of the light propagation modes coincide with each other at the wavelength of 1550 nm and the wavelength of 3100 nm. For example, in a case where the core width of the second core 103 is 800 nm, the phase matching condition can be obtained when the core width of the first core 102 is around 650 nm. In a case where the core width of the second core 103 is 850 nm, the phase matching condition can be obtained when the core width of the first core 102 is around 1500 nm.

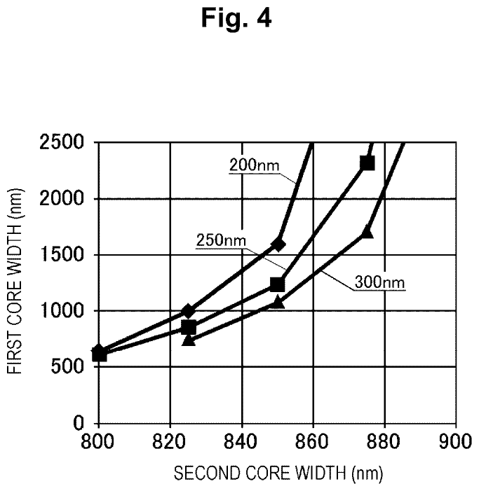

Next, a distance between the first core 102 and the second core 103 will be described. FIG. 4 illustrates a relationship between a core width (first core width) of the first core 102 and a core width (second core width) of the second core 103 in which the phase matching condition is obtained in a case where a distance between the first core 102 and the second core 103 is changed. The number in FIG. 4 indicates a distance between the first core 102 and the second core 103. It can be seen that the longer the distance between the first core 102 and the second core 103, the larger the core width of the second core 103 from which the phase matching condition is obtained.

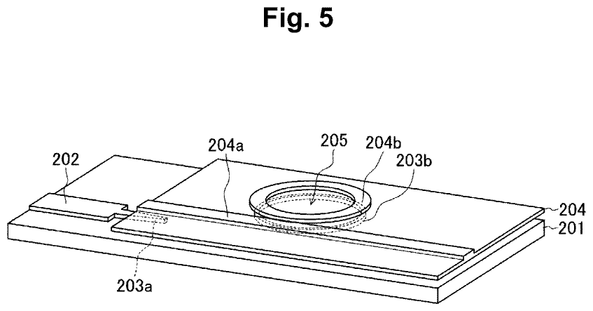

Next, an example in which the optical device according to the embodiment is applied to an integrated optical device will be described with reference to FIG. 5. This integrated optical device is a combination of a semiconductor laser light source and the optical device according to the embodiment.

In this device, first, a membrane laser 202 (Reference Literature 1), an output optical waveguide core 203a of the membrane laser 202, and a lower ring core 203b are formed on a substrate 201. The output optical waveguide core 203a and the lower ring core 203b are made of InP.

An LN layer 204 made of lithium niobate is disposed on the substrate 201. In the LN layer 204, a linear core 204a optically coupled to the output optical waveguide core 203a and an upper ring core 204b formed at a position overlapping the lower ring core 203b in a plan view are formed. The linear core 204a and the upper ring core 204b are formed of ribs formed in the LN layer 204.

The LN layer 204 is disposed apart above the substrate 201 at a predetermined distance in a range in which the lower ring core 203b and the upper ring core 204b constitute the optical waveguide having the super mode, without being in contact with the upper ends of the output optical waveguide core 203a and the lower ring core 203b. The upper ring core 204b is the first core 102 of the optical device according to the above-described embodiment, and the lower ring core 203b is the second core 103 of the optical device according to the above-described embodiment. The optical waveguide including the linear core 204a and the ring optical waveguide 205 including the lower ring core 203b and the upper ring core 204b constitute a ring resonator. The ring optical waveguide 205 is an optical waveguide satisfying the phase matching condition of Expression (1).

As described above, in a case where the optical device according to the embodiment is optically coupled to the membrane laser 202 that is another optical device, a core height of the first core may be set to a height for matching with another optical device optically coupled to the optical waveguide using the first core. Similarly, a core height of the second core may be a height for matching with another optical device optically coupled to the optical waveguide using the second core. With this configuration, another optical device (membrane laser 202) and the optical device (ring optical waveguide 205) according to the embodiment can be easily integrated.

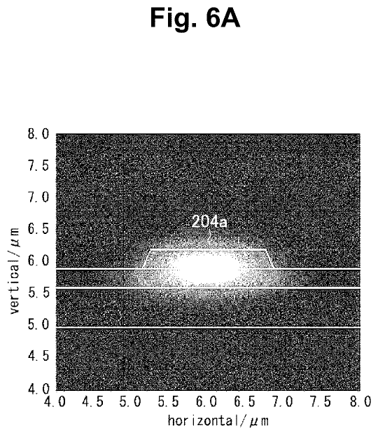

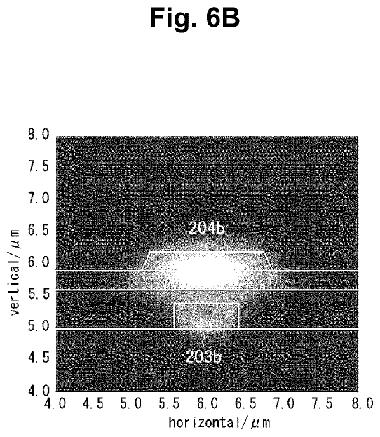

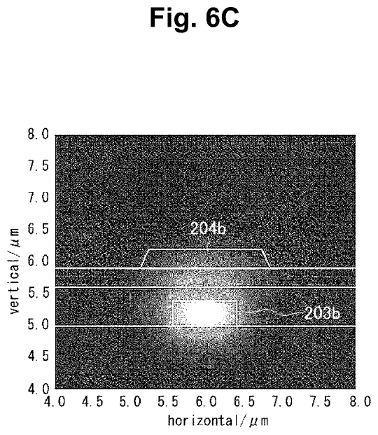

In the integrated optical device described above, in the optical waveguide using the linear core 204a coupled to the optical waveguide using the output optical waveguide core 203a, regarding a propagation mode of light, an electromagnetic field exists in the linear core 204a in the propagation light mode at 1550 nm as illustrated in FIG. 6A.

The output optical waveguide core 203a has a gradually tapered width, is subjected to adiabatic mode conversion in the course of propagation of the output light from the membrane laser 202, and has a propagation light mode in which an electromagnetic field mainly exists in the linear core 204a at the tapered tip, and is coupled to the optical waveguide using the linear core 204a having the propagation mode as illustrated in FIG. 6A and is optically wired thereafter.

The optical waveguide using the linear core 204a is optically coupled to the ring optical waveguide 205 including the nonlinear optical waveguide satisfying the phase matching condition according to the present invention. In the ring optical waveguide 205, input light having the wavelength of 1550 nm illustrated in FIG. 6B and SPDC light having the wavelength of 3100 nm satisfying the phase matching condition illustrated in FIG. 6C are generated. Each of the pieces of light generated in the ring optical waveguide 205 is optically coupled to the optical waveguide using the linear core 204a and is output. A linear core made of InP may be provided in the same layer as the output optical waveguide core 203a on the lower side of the linear core 204a. With this configuration, also in this region, it is possible to obtain a nonlinear optical waveguide satisfying the phase matching condition according to the embodiment by using the linear core 204a (first core) and the linear core (second core).

In the integrated optical device described above, for example, the ring optical waveguide 205 configuring the ring resonator is designed to have anomalous dispersion, and an oscillation wavelength of the membrane laser 202 is swept from the short wavelength side to the long wavelength side across a resonance wavelength of the ring resonator, whereby frequency comb light is obtained through the χ⁽²⁾ nonlinear process and the χ⁽³⁾ nonlinear process in the ring optical waveguide 205. That is, an integrated comb light source in which an excitation laser (membrane laser 202) and a nonlinear microresonator (ring optical waveguide 205) are integrated can be realized. Here, the membrane laser has been described as an example, but another membrane device, for example, a phase shifter for generating a soliton in a nonlinear microresonator or a heater structure for tuning a wavelength of a ring resonator may be integrated with the nonlinear optical waveguide satisfying the phase matching condition according to the present invention.

As described above, according to the present invention, the first core and the second core constitute an optical waveguide having the super mode, and a refractive index, a sectional shape of each of the first core and the second core, and a positional relationship between the first core and the second core in a section perpendicular to the waveguide direction have a relationship in which a propagation constant of input light is equal to a sum of propagation constants of two light waves generated through the nonlinear process by the input light propagating through the optical waveguide having the super mode. Therefore, a loss in a bent optical waveguide can be suppressed, and the nonlinear optical effect can be easily exhibited even in a case where the ring resonator is used.

Note that the present invention is not limited to the above embodiment, and it is clear that various modifications and combinations can be implemented by those skilled in the art without departing from the technical spirit of the present invention.

[Reference Literature 1] H. Nishi et al., “Integration of Eight-Channel Directly Modulated Membrane-Laser Array and SiN AWG Multiplexer on Si”, Journal of Lightwave Technology, vol. 37, no. 2, pp. 266-273, 2019.

### REFERENCE SIGNS LIST

101 Lower cladding layer
102 First core
103 Second core
104a Intermediate cladding layer
104b Upper cladding layer
121 Slab layer

1. An optical device comprising:
a first core formed on a substrate; and
a second core with a nonlinear optical effect disposed above the first core, wherein
the first core and the second core are configured to constitute an optical waveguide having a super mode in which electromagnetic field distribution exists in both the first core and the second core, and
a refractive index and a sectional shape of each of the first core and the second core, and a positional relationship between the first core and the second core in a section perpendicular to a waveguide direction of the optical waveguide have a relationship in which a propagation constant of input light is equal to a sum of propagation constants of two light waves generated through a nonlinear process by the input light propagating through the optical waveguide having the super mode.

2. The optical device according to claim 1, wherein
a core height of the first core is set to a height for matching with another optical device optically coupled to an optical waveguide using the first core.

3. The optical device according to claim 1, wherein
a core height of the second core is set to a height for matching with another optical device optically coupled to an optical waveguide using the second core.

4. The optical device according to claim 2, wherein
a core height of the second core is set to a height for matching with another optical device optically connected to an optical waveguide using the second core.

5. The optical device according to claim 1, wherein
the first core and the second core are formed in a ring shape in plan view to form a first ring waveguide and a second ring waveguide, respectively, and
the second core overlaps the first core in plan view.

6. The optical device according to claim 5, further comprising:
a liner optical waveguide including a liner core formed in a layer in which the second ring waveguide is formed, such that the liner optical wave guide, the first ring waveguide and the second ring waveguide constitute a ring resonator.

7. The optical device according to claim 6, further comprising:
a laser formed on the substrate, and
an optical waveguide formed on the substrate and coupled with the laser for guiding light output from the laser,
wherein the liner optical waveguide is optically coupled with the optical waveguide.
